(19) United States
(12) Patent Application Publication
(10) Pub. No.: US 2004/0151635 A1
(43) Pub. Date: Aug. 5, 2004

(54) Array fabrication using deposited drop splat size

(76) Inventors: Eric M. Leproust, Campbell, CA (US); Bill J. Peck, Mountain View, CA (US); James R. Culkar JR., San Francisco, CA (US); Winny W. Ke, San Jose, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/355,710

(22) Filed: Jan. 31, 2003

(51) Int. Cl. G01N 1/10

(52) U.S. Cl. 422/100; 436/180

(57) ABSTRACT

Methods for fabricating chemical arrays, such as biopolymer arrays. The method may include depositing drops which contain probes or probe precursors from positions spaced from the surface onto the feature locations, so that each of the probes or probe precursors binds to the different feature locations. This is repeated as needed at the same feature locations so as to form the array. Drop spacing may be controlled based on deposited drop splat dimensions. Apparatus, computer program products, and arrays are also provided.

### FIELD OF THE INVENTION

This invention relates to arrays, such as polynucleotide arrays (for example, DNA arrays), which are useful in diagnostic, screening, gene expression analysis, and other applications.

### BACKGROUND OF THE INVENTION

In the following discussion and throughout the present application, while various references are cited no cited reference is admitted to be prior art to the present application.

Chemical arrays, such as polynucleotide or protein arrays (for example, DNA or RNA arrays), are known and are used, for example, as diagnostic or screening tools. Polynucleotide arrays include regions of usually different sequence polynucleotides arranged in a predetermined configuration on a substrate. These regions (sometimes referenced as “features”) are positioned at respective locations (“addresses”) on the substrate. The arrays, when exposed to a sample, will exhibit an observed binding pattern. This binding pattern can be detected upon reading the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample.

Biopolymer arrays can be fabricated by depositing previously obtained biopolymers (such as from synthesis or natural sources) onto a substrate, or by in situ synthesis methods. Methods of depositing obtained biopolymers include loading then touching a pin or capillary to a surface, such as described in U.S. Pat. No. 5,807,522 or deposition by firing from a pulse jet such as an inkjet head, such as described in PCT publications WO 95/25116 and WO 98/41531, and elsewhere. Such a deposition method can be regarded as forming each feature by one cycle of attachment (that is, there is only one cycle at each feature during which the previously obtained biopolymer is attached to the substrate). For in situ fabrication methods, multiple different reagent droplets are deposited by pulse jet or other means at a given target location in order to form the final feature (hence a probe of the feature is synthesized on the array substrate). The in situ fabrication methods include those described in U.S. Pat. No. 5,449,754 for synthesizing peptide arrays, and in U.S. Pat. No. 6,180,351 and WO 98/41531 and the references cited therein for polynucleotides, and may also use pulse jets for depositing reagents. The in situ method for fabricating a polynucleotide array typically follows, at each of the multiple different addresses at which features are to be formed, the same conventional iterative sequence used in forming polynucleotides from nucleoside reagents on a support by means of known chemistry. This iterative sequence can be considered as multiple ones of the following attachment cycle at each feature to be formed: (a) coupling an activated selected nucleoside (a monomeric unit) through a phosphite linkage to a functionalized support in the first iteration, or a nucleoside bound to the substrate (i.e. the nucleoside-modified substrate) in subsequent iterations; (b) optionally, blocking unreacted hydroxyl groups on the substrate bound nucleoside (sometimes referenced as “capping”); (c) oxidizing the phosphite linkage of step (a) to form a phosphate linkage; and (d) removing the protecting group (“deprotection”) from the now substrate bound nucleoside coupled in step (a), to generate a reactive site for the next cycle of these steps. The coupling can be performed by depositing drops of an activator and phosphoramidite at the specific desired feature locations for the array. A final deprotection step is provided in which nitrogenous bases and phosphate group are simultaneously deprotected by treatment with ammonium hydroxide and/or methylamine under known conditions. Capping, oxidation and deprotection can be accomplished by treating the entire substrate (“flooding”) with a layer of the appropriate reagent. The functionalized support (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in another flooding procedure in a known manner. Conventionally, a single pulse jet or other dispenser is assigned to deposit a single monomeric unit.

The foregoing chemistry of the synthesis of polynucleotides is described in detail, for example, in Caruthers, Science 230: 281-285, 1985; Itakura et al., Ann. Rev. Biochem. 53: 323-356; Hunkapillar et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. No. 4,458,066, U.S. Pat. No. 4,500,707, U.S. Pat. No. 5,153,319, U.S. Pat. No. 5,869,643, EP 0294196, and elsewhere. The phosphoramidite and phosphite triester approaches are most broadly used, but other approaches include the phosphodiester approach, the phosphotriester approach and the H-phosphonate approach. The substrates are typically functionalized to bond to the first deposited monomer. Suitable techniques for functionalizing substrates with such linking moieties are described, for example, in U.S. Pat. No. 6,258,454 and Southern, E. M., Maskos, U. and Elder, J. K., Genomics, 13, 1007-1017, 1992. In the case of array fabrication, different monomers and activator may be deposited at different addresses on the substrate during any one cycle so that the different features of the completed array will have different desired biopolymer sequences. One or more intermediate further steps may be required in each cycle, such as the conventional oxidation, capping and washing steps in the case of in situ fabrication of polynucleotide arrays (again, these steps may be performed in flooding procedure).

Further details of fabricating biopolymer arrays by depositing either previously obtained biopolymers or by the in situ method are disclosed in U.S. Pat. No. 6,242,266, U.S. Pat. No. 6,232,072, U.S. Pat. No. 6,180,351, and U.S. Pat. No. 6,171,797. In array fabrication, the quantities of polynucleotide available are usually very small and expensive. Additionally, sample quantities available for testing are usually also very small and it is therefore desirable to simultaneously test the same sample against a large number of different probes on an array. These conditions make it desirable to produce arrays with large numbers of very small, closely spaced features. Furthermore, the features should have distinct boundaries which do not overlap other features, so as to reduce errors from reading the array.

### SUMMARY OF THE INVENTION

The present invention then provides in one aspect a method of fabricating an array of chemical probes (for example, biopolymer or other polymer probes) bound to a surface of a substrate at different feature locations of the array. The method includes depositing drops which contain probes or probe precursors from positions spaced from the surface onto the feature locations, so that each of the probes or probe precursors binds to the different feature locations. This is repeated as needed at the same feature locations so as to form the array. Drops deposited during a same cycle at adjacent feature locations produce resulting splat dimensions which do not contact one another and which are spaced apart by less than 35% of a largest one of their splat dimensions, or each of which does not exceed its maximum resting dimension by more than 8%, or both.

In another aspect, the invention provides a method which includes determining the splat dimension of a last drop in a series of drops deposited onto a same location on a surface.

The present invention also provides a method which includes determining the splat dimension of drops containing a polynucleotide, peptide, or monomer units of either, which are deposited onto a surface from positions spaced therefrom. In either of these two situations the present invention may further include fabricating an array in which the spacing of feature locations is selected based on the determined splat dimension.

An array of chemical probes bound to a surface of a substrate at different features of the array, is also provided by the present invention. The array may have at least one thousand features each with a maximum dimension of between 20 to 150 microns and which are spaced apart from adjacent features by less than 35% of their maximum dimension (that is, the largest linear dimension, such as diameter, taken from both).

There is further provided by the present invention, apparatus, and computer program products, which can execute one or more methods of the present invention. Computer program products include a computer readable medium carrying program code which can execute a method of the present invention. Apparatus of the present invention includes a drop deposition system with one or more drop deposition units (such as one or more pulse jets), to deposit the required drops and a processor to control the drop deposition units to deposit drops in accordance with a method of the present invention. A substrate holder may also be provided with a transport system moving the deposition system in relation to a substrate on the holder.

The various aspects of the present invention can provide any one or more of the following and/or other useful benefits. For example, arrays can be provided with very closely spaced features. The features may also have relatively distinct boundaries.

### BRIEF DESCRIPTION OF THE DRAWINGS

FIG. 1 illustrates an array assembly carrying multiple arrays, such as may be fabricated by methods of the present invention;

FIG. 2 is an enlarged view of a portion of FIG. 1 showing multiple ideal spots or features of an array;

FIG. 3 is an enlarged illustration of a portion of FIG. 2;

FIGS. 4A-4C illustrate the impact of individual drops in a series of seven drops onto a same location on a surface; FIG. 4A shows one drop impacting on a clean surface; FIG. 4B shows the impact of a second drop in the series onto the sessile (resting) drop on the surface formed from the previous drop in FIG. 4A; FIG. 4C shows the impact of the seventh drop in the series onto the sessile (resting) drop on the surface formed from the previous six drops;

FIG. 4D shows graphs illustrating the diameter (in microns on the Y axis) of each drop over time (in microseconds on the X axis), with the upper left most graph showing the first drop from FIG. 4A, the upper right most graph showing drop from FIG. 4B, the lower left most graph showing the seventh drop from FIG. 4C, and the lower right most graph showing the diameter for each of the seven drops in the series;

FIG. 5 is a block diagram of an apparatus for obtaining the series of images in FIG. 4 and visualizing splat dimension;

FIGS. 6 and 7 illustrate the relation of splat diameter to feature spacing;

FIG. 8 illustrates possible splat dimension spacings in fabricating arrays according to methods of the present invention;

FIG. 9 is a graph showing the ratio of splat diameter to final feature size for a series of drops, versus the number of drops in the series;

FIG. 10 shows images of an array, fabricated without control of splat diameter in accordance with the present invention or matching of surface and drop properties, following exposure to a sample;

FIG. 11 shows images similar to those of FIG. 10 but of an array fabricated in accordance with the present invention;

FIG. 12 is a flowchart illustrating a method of the present invention; and

FIG. 13 schematically illustrates an apparatus for fabricating arrays according to a method of the present invention.

To facilitate understanding, the same reference numerals have been used, where practical, to designate the same elements that are common to the figures. Different letters after the same number indicate members of a generic class (for example, arrays 12a, 12b may be collectively referred to as “arrays 12”). Drawings are not necessarily to scale.

### DETAILED DESCRIPTION OF EMBODIMENTS OF THE INVENTION

In the present application, unless a contrary intention appears, the following terms refer to the indicated characteristics. A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

An “array”, unless a contrary intention appears, includes any one, two or three-dimensional arrangement of addressable regions bearing a particular chemical moiety or moieties (for example, biopolymers such as polynucleotide sequences) associated with that region. Each region may extend into a third dimension in the case where the substrate is porous while not having any substantial third dimension measurement (thickness) in the case where the substrate is non-porous. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). An array feature is generally homogenous and the features typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probes” may be the one which is to be evaluated by the other (thus, either one could be an unknown mixture of polynucleotides to be evaluated by binding with the other). An “array layout” or “array characteristics”, refers to one or more physical, chemical or biological characteristics of the array, such as feature positioning, one or more feature dimensions, or some indication of an identity or function (for example, chemical or biological) of a moiety at a given location, or how the array should be handled (for example, conditions under which the array is exposed to a sample, or array reading specifications or controls following sample exposure). “Hybridizing” and “binding”, with respect to polynucleotides, are used interchangeably.

A “plastic” is any synthetic organic polymer of high molecular weight (for example at least 1,000 grams/mole, or even at least 10,000 or 100,000 grams/mole. “Flexible” with reference to a substrate or substrate web, references that the substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

A “web” references a long continuous piece of substrate material having a length greater than a width. For example, the web length to width ratio may be at least 5/1, 10/1, 50/1, 100/1, 200/1, or 500/1, or even at least 1000/1.

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. An array “assembly” may be the array plus only a substrate on which the array is deposited, although the assembly may be in the form of a package which includes other features (such as a housing with a chamber). A “chamber” references an enclosed volume (although a chamber may be accessible through one or more ports). It will also be appreciated that throughout the present application, that words such as “front”, “back”, “top”, “upper”, and “lower” are used in a relative sense only. “Fluid” is used herein to reference a liquid. Reference to a singular item, includes the possibility that there are plural of the same items present. “May” refers to optionally. Any recited method can be carried out in the ordered sequence of events as recited, or any other logically possible sequence.

A “pulse jet” is any device which can dispense drops in the formation of an array. Pulse jets operate by delivering a pulse of pressure (such as by a piezoelectric or thermoelectric element) to liquid adjacent an outlet or orifice such that a drop will be dispensed therefrom.

A “linking layer” bound to the surface may, for example, be less than 200 angstroms or even less than 10 angstroms in thickness (or less than 8, 6, or 4 angstroms thick). Such layer may have a polynucleotide, protein, nucleoside or amino acid minimum binding affinity of 10⁴ to 10⁶ units/μ². Layer thickness can be evaluated using UV or X-ray elipsometry.

A “group” in relation to a chemical formula, includes both substituted and unsubstituted forms of the group.

“Lower alkyl group” is an alkyl group with from 1 to 6 C atoms, and may only have any one of 1, 2, 3, or 4 C atoms.

“Surface energy” is as defined in U.S. Pat. No. 6,444,268. A surface which is more hydrophobic (less hydrophilic) has a lower surface energy than a surface which is less hydrophobic (more hydrophilic).

A “region” on a substrate surface is a continuous area on that surface, with different regions not overlapping one another. Typically, a particular region will contain multiple features (such as at least ten, at least fifty, at least one or two hundred, or at least one thousand) of the same probe density. Each region may have an area of at least 1 mm², or at least 10 mm², at least 100 mm², or at least 200 mm².

“Feature density” is the number of features per unit area of the array. This is distinct from “probe density” (sometimes referenced as “feature probe density”) which is a shorthand way of referring to the number of linker molecules or probe molecules per unit area within a feature. Thus, any interfeature areas which are essentially devoid of the probe are not taken into consideration in determining a probe density.

“Splat dimension” in relation to a deposited drop, refers to a maximum dimension assumed on the surface after the drop has impacted the surface. The maximum dimension, in the case where there is no other liquid on the surface (for example, from previously deposited drops in a series) will result from the deposited drop only. Where there is other liquid on the surface at the drop impact (for example, from previously deposited drops in a series) the maximum dimension is that assumed by the resulting total liquid volume at the impact location (that is, the liquid on the surface at the impact location plus the deposited drop). A splat dimension may be a “splat diameter” where only one drop impacts the surface or the resting drop plus the deposited drop in a series forms a round configuration. A splat radius is ½ the splat dimension (including ½ the splat diameter for the round situation mentioned). “Spacing” or “spaced apart” distance and similar terms when referring to spacings between splat dimensions (such as splat diameters), refers to the shortest distance between splat dimensions (that is, the distance as measured between the closest positions on those splat dimensions).

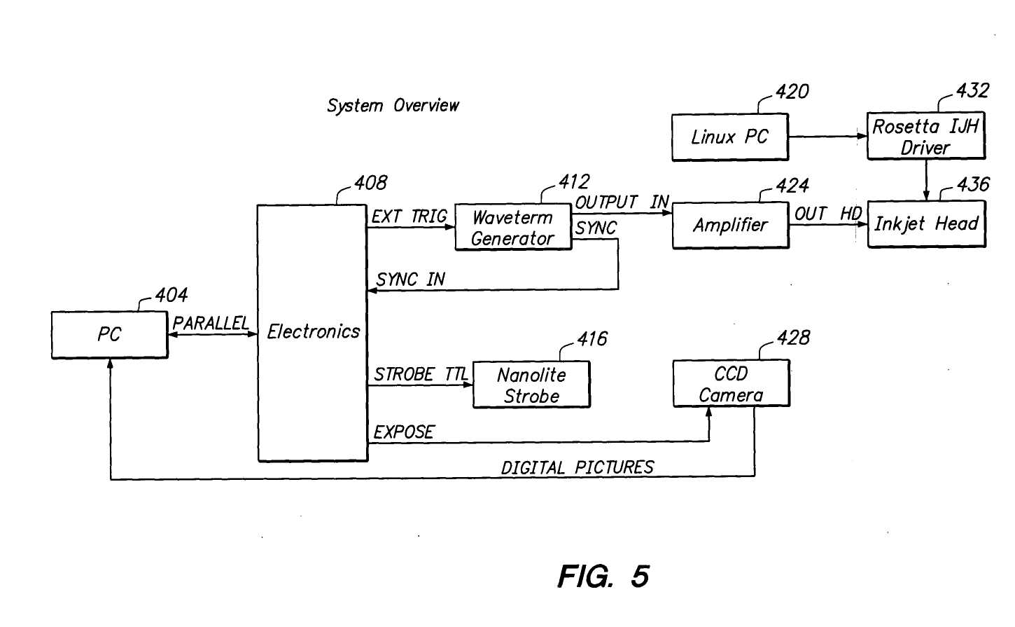

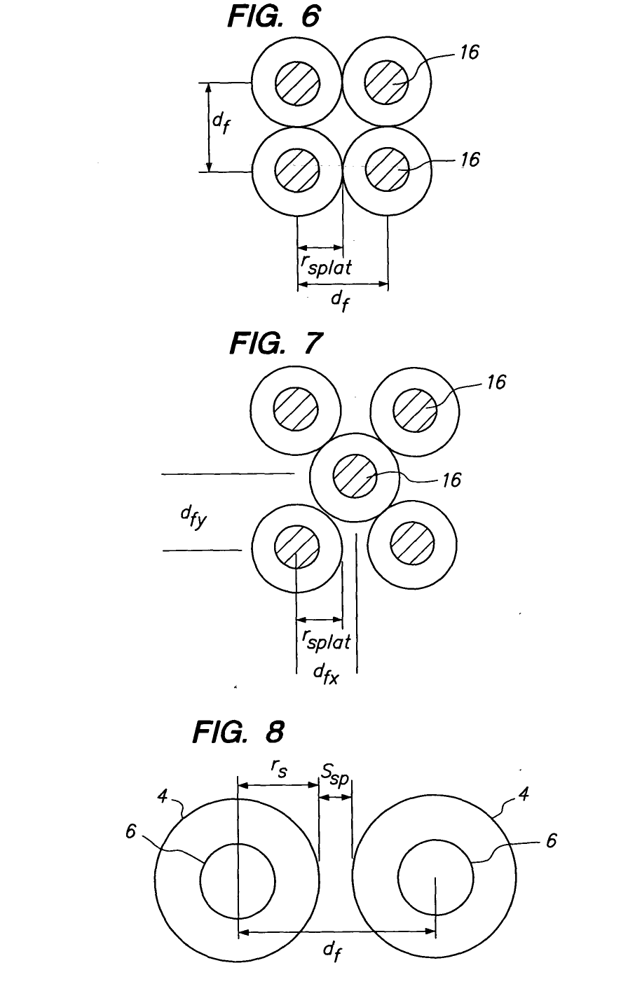

Reference to a largest one of the splat dimensions or the like, particularly when referring to drops deposited at adjacent feature locations, means the largest splat dimension produced by those drops or, when the splat dimensions are equal, then either one of those splat dimensions. A feature (or feature location) is “adjacent” another feature (or feature location) when it is the closest feature (measured edge to edge) to that other feature. When all feature (or feature locations) are equally spaced then each feature may have multiple adjacent features. For example, in FIG. 6 each of the four shown feature locations is shown with only two adjacent feature locations.

A “series” of drops deposited at a location refers to drops which are deposited during a same cycle at that location such that they all remain liquid while all members of the series are deposited.

The steps of any method herein may be performed in the recited order, or in any other order that is logically possible. All patents and other references cited in this application, are incorporated into this application by reference except insofar as anything in those patents or references, including definitions, conflicts with anything in the present application (in which case the present application is to prevail).

In methods of the present invention, a series of multiple drops may be deposited onto each feature location during a same cycle. The deposition of one or a series of drops at each feature during a cycle may be repeated multiple times during subsequent cycles (using drops of the same or different composition as in previous cycles). Drops deposited during a same cycle for each of adjacent feature locations may be single drops only or drops in a series of drops for each location (for example a last drop in the series). Such drops may or may not be simultaneously deposited, and produce resulting splat dimensions which do not contact one another and are spaced apart by less than 70%, 60% 50%, 35%, 25%, 20%, 15% 10%, 5%, or 2% of a largest one of their splat dimensions. Note that when drops for adjacent feature locations are not simultaneously deposited (that is, one is deposited before the other) it will in practice be possible to space them closer together. This is so since in the case of adjacent simultaneously deposited drops they both expand to their maximum splat dimension at about the same time. On the other hand where one drop is deposited before a drop at an adjacent feature location the previously deposited drop will already be in a resting state.

In methods of the present invention, prior to depositing the drops, the splat dimension for drops deposited during a same cycle (such as the last drops deposited in a series of drops) at adjacent feature locations may be determined. A feature location spacing may then be selected for the array based on the determined splat dimension. This determination may be made using drops of the same composition as the drops to be deposited for the arrays during the same cycle, or using drops of different composition and theoretically determining the expected splat dimension.

In the method for determining splat dimension of drops, as mentioned above, the method may additionally include fabricating an array of chemical probes bound to a surface of a substrate at different feature locations of the array. This fabricating method includes, based on the determined splat dimension, selecting a set of conditions for depositing a series of drops containing polynucleotide, peptide, or monomer units of either onto the substrate surface from positions spaced therefrom, so that drops simultaneously deposited at adjacent features will not contact one another. A series of drops are deposited from positions spaced from the surface onto the feature locations under the selected conditions, so that each of the probes or probe precursors binds to the different feature locations. The foregoing depositing is repeated as needed at the same feature locations so as to form the array. The selected set of conditions may include a same drop volume, velocity, viscosity, and distance from the substrate surface from which they are deposited, as used in the determining of splat dimension. These may be selected such that the splat dimension does not exceed resting drop size by more than 40%, 30%, 20%, 15%, 10%, 8%, 6%, 5%, 4%, or 2% Any computer readable storage medium for any purpose herein may include, for example, an optical or magnetic memory (such as a fixed or portable disk or other device), or a solid state memory.

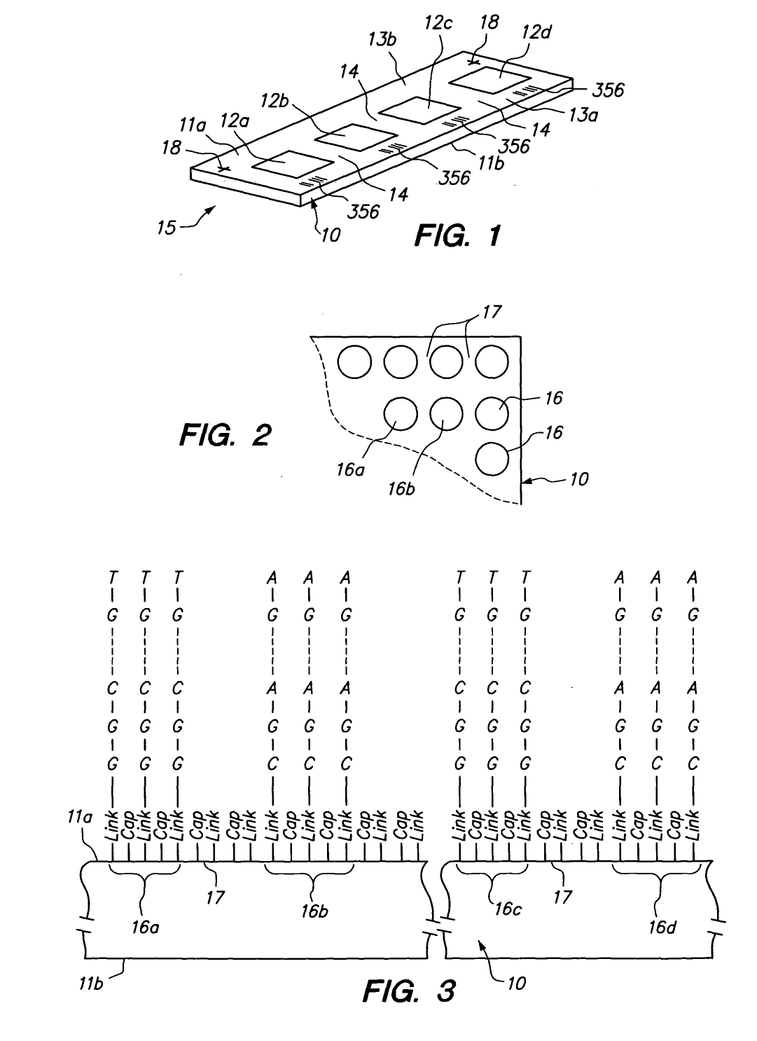

Referring first to FIGS. 1-3, an array assembly 15 (which may be referenced also as an “array unit”) of the present invention may include a substrate which can be, for example, in the form of an a rigid substrate 10 (for example, a transparent non-porous material such as glass or silica) of limited length, carrying one or more arrays 12 disposed along a front surface 11a of substrate 10 and separated by inter-array areas 14. Throughout this application any different members of a generic class may have the same reference number followed by different letters (for example, arrays 12a, 12b, 12c, and 12d may generically be referenced as “arrays 12”) Alternatively, substrate 10 can be flexible. Each array 12 occupies its own region on surface 11a which is co-extensive with the array (hence the regions do not extend into areas 14). A back side 11b of substrate 10 does not carry any arrays 12. The arrays on substrate 10 can be designed for testing against any type of sample, whether: a trial sample; reference sample; a combination of the foregoing; or a known mixture of polynucleotides, proteins, polysaccharides and the like (in which case the arrays may be composed of features carrying unknown sequences to be evaluated). While four arrays 12 are shown in FIG. 1, it will be understood that substrate 10 and the embodiments to be used with it, may use any number of desired arrays 12 such as at least one, two, five, ten, twenty, fifty, or one hundred (or even at least five hundred, one thousand, or at least three thousand). When more than one array 12 is present they may be arranged end to end along the lengthwise direction of substrate 10. Depending upon intended use, any or all of arrays 12 may be the same or different from one another and each will contain multiple spots or features 16 of biopolymers in the form of polynucleotides.

A typical array 12 may contain from more than ten, more than one hundred, more than one thousand or ten thousand features, or even more than from one hundred thousand features. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature of the same composition are excluded, the remaining features may account for at least 5%, 10%, or 20% of the total number of features).

In any aspect of the present invention, adjacent features 16 may be spaced apart by a distance greater than 0 and less than 70%, 60% 50%, 35%, 25%, 20%, 15%, 10%, or 5% of a maximum dimension of the adjacent features. Further, the features may have a maximum dimension of between 20 (or 50) to 125 (or 100 or 80) microns and are spaced apart by less than 50 microns (or by less than 40, 30, 20, or 15 microns). Various feature densities on the substrate surface are possible. For example, features having a maximum dimension greater than any of the foregoing figures may be present on the surface of at least 30 features/mm², 40 features/mm², or 60 features/mm². While round features 16 are shown, various other feature shapes are possible (such as elliptical).

Each array 12 may cover an area of less than 100 cm², or even less than 50 cm², 10 cm² or 1 cm². In many embodiments, particularly when substrate 10 is rigid, it may be shaped generally as a rectangular solid (although other shapes are possible), having a length of more than 4 mm and less than I m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. When substrate 10 is flexible, it may be of various lengths including at least 1 m, at least 2 m, or at least 5 m (or even at least 10 m). With arrays that are read by detecting fluorescence, the substrate 10 may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

In the case where arrays 12 are formed by the conventional in situ or deposition of previously obtained moieties, as described above, by depositing for each feature a droplet of reagent in each cycle such as by using a pulse jet such as an inkjet type head, interfeature areas 17 will typically be present which do not carry any polynucleotide. It will be appreciated though, that the interfeature areas 17 could be of various sizes and configurations. It will also be appreciated that there need not be any space separating arrays 12 from one another. Each feature carries a predetermined polynucleotide (which includes the possibility of mixtures of polynucleotides). As per usual, A, C, G, T represent the usual nucleotides. “Link” (see FIG. 3 in particular) represents a linking agent (molecule) covalently bound to the front surface and a first nucleotide, as provided by a method of the present invention and as further described below. The Link serves to functionalize the surface for binding by the first nucleotide. “Cap” represents a capping agent. The Link may be any of the “second silanes” referenced in U.S. Pat. No. 6,444,268 while the Cap may be any of the “first silanes” in that patent. However, different linking layer compositions than those silanes could be used (for example, where the array is fabricated by deposition of previously obtained polynucleotides, a layer of polylysine or other compositions described in U.S. Pat. No. 6,319,674 adhered to the substrate surface, may be used to functionalize the surface). As already mentioned, the foregoing patents are incorporated herein by reference, including for example the details of the linking layer compositions used therein.

Substrate 10 also one or more identifiers in the form of bar codes 356. Identifiers such as other optical or magnetic identifiers could be used instead of bar codes 356 which will carry the information discussed below. Each identifier may be associated with its corresponding array by being positioned adjacent that array 12. However, this need not be the case and identifiers such as bar code 356 can be positioned elsewhere on substrate 10 if some other means of associating each bar code 356 with its corresponding array is provided (for example, by relative physical locations). Further, a single identifier might be provided which is associated with more than one array 12 on a same substrate 10 and such one or more identifiers may be positioned on a leading or trailing end of substrate 10. The substrate may further have one or more fiducial marks 18 for alignment purposes during array fabrication.

FIGS. 2 and 3 illustrate ideal features 16 of an array 12 where the actual features formed are the same as the target (or “aim”) features, with each feature 16 being uniform in shape, size and composition, and the features being regularly spaced. Such an array when fabricated by drop deposition methods, would require all reagent droplets for each feature to be uniform in shape and accurately deposited at the target feature location. In practice, such an ideal result may be difficult to obtain due to fixed and random errors during fabrication.

Arrays 12 may be fabricated on the functionalized surface 11a by depositing onto the continuous functionalized area on the substrate surface, drops containing the chemical probes or probe precursors at the multiple feature locations of the array to be fabricated, so that the probes or probe precursors bind to the linking agent at the feature locations. This step may be repeated in subsequent “cycles” at one or more features, particularly when the in situ method of fabricating biopolymers is used. Usually no repetition is required (that is, there is only one cycle) where the array is formed by depositing previously obtained biopolymers. Such methods and their chemistry are described in detail in the references cited in the “Background” section above, including for example U.S. Pat. No. 6,242,266, U.S. Pat. No. 6,232,072, U.S. Pat. No. 6,180,351, U.S. Pat. No. 6,171,797, U.S. Pat. No. 6,323,043, U.S. and U.S. patent application Ser. No. 09/302,898 filed Apr. 30, 1999 by Caren et al., and the references cited in them.

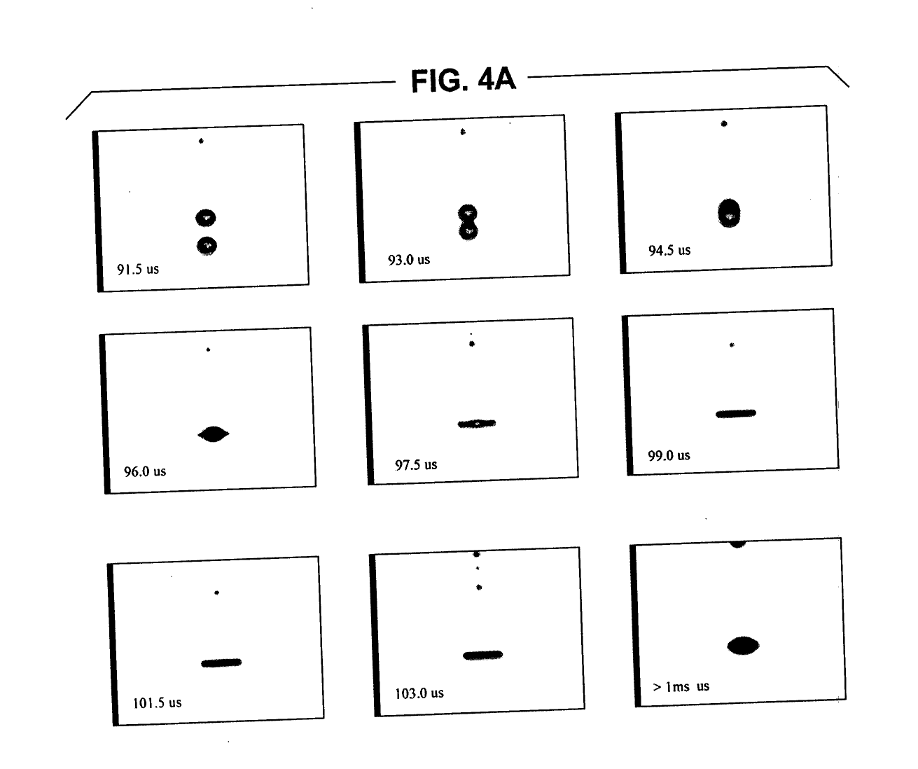

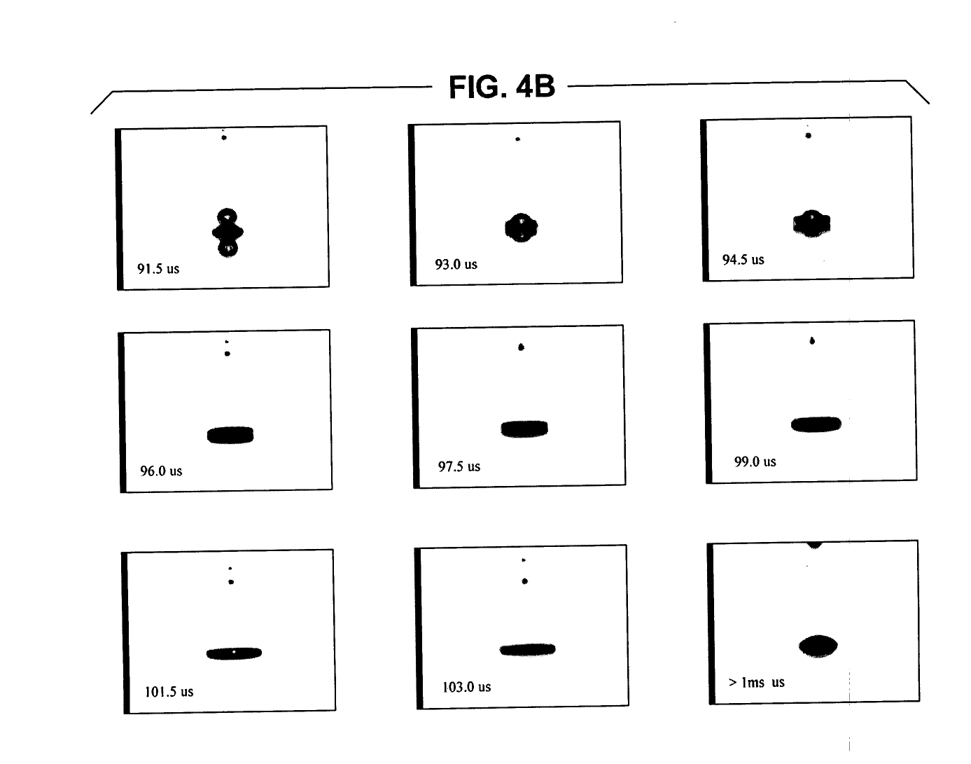

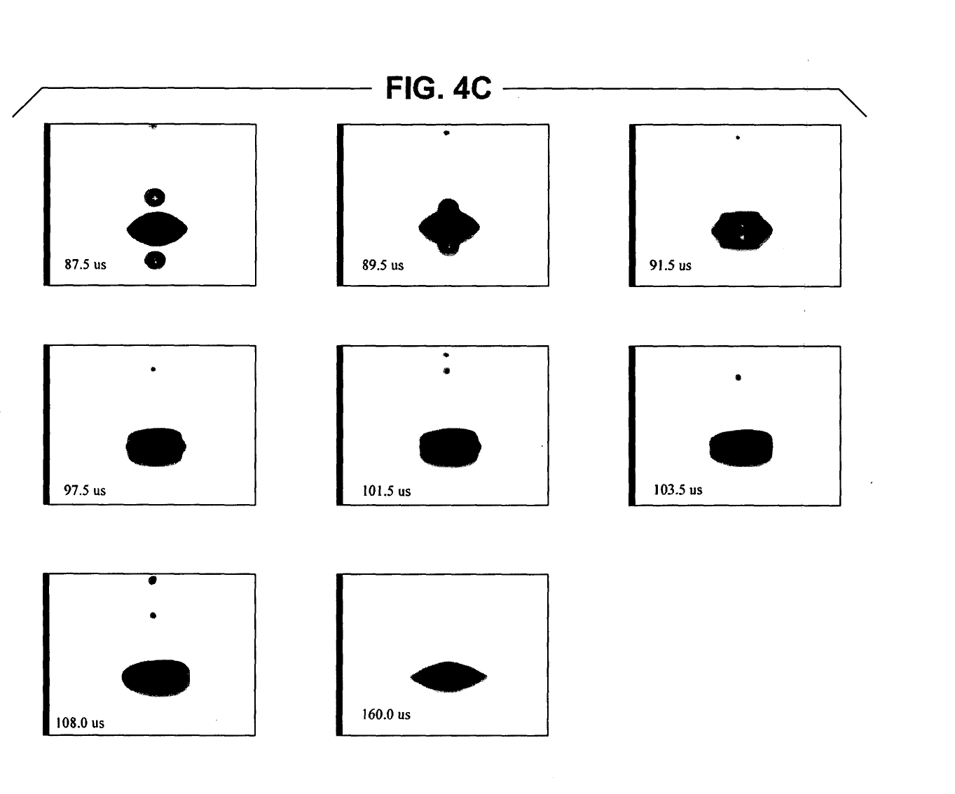

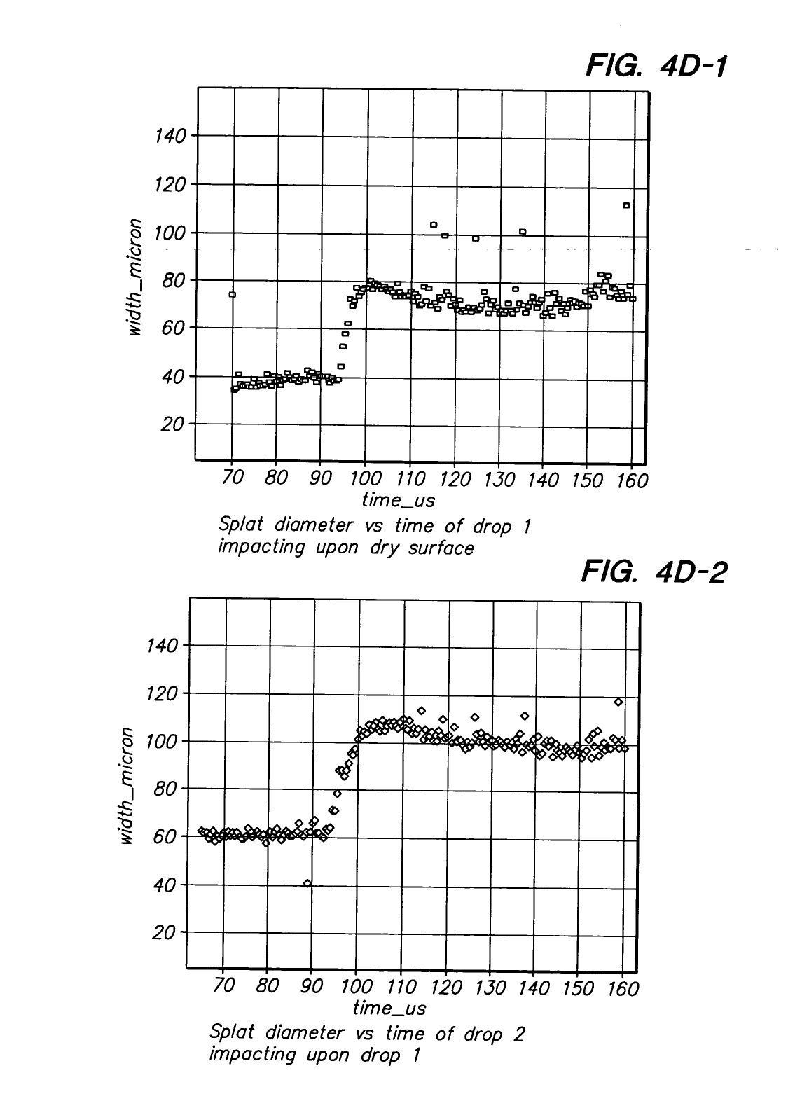

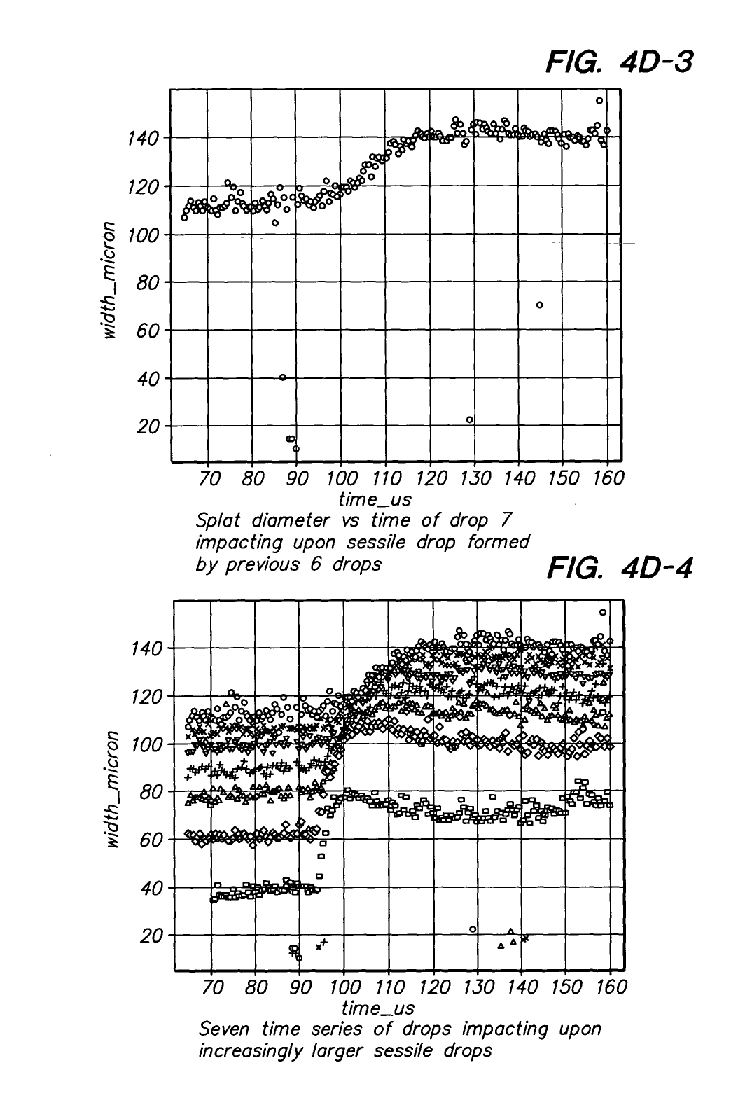

The operation of aspects of the invention can be understood by considering FIGS. 4-11. Turning first to FIG. 4A this shows one drop impacting on a clean surface. Similarly, FIG. 4B shows the impact of a second drop in the series onto the sessile (resting) drop on the surface formed from the previous drop in FIG. 4A; FIG. 4C shows in the same manner the impact of the seventh drop in the series onto the sessile (resting) drop on the surface formed from the previous six drops. Each image in the image series shown in FIGS. 4A, 4B, 4C was captured by flashing a strobe at the indicated times (in microseconds). Each image within each image series is from different experiments under the same conditions. Note that the previously deposited drop or drops are relatively stationary (resting) on the surface forming a round drop prior to the impact of the next drop in the series. As the next drop impacts the resting droplet the newly resulting droplet expands outward to a maximum diameter, the splat diameter dₛₚₗₐₜ then retracts inward to a resting diameter. This can be most clearly seen from the graphs of the respective drop diameters provided in FIG. 4D.

A suitable apparatus for measuring the foregoing behaviour and splat diameter is illustrated in block form in FIG. 5. The drive voltage for a piezoelectric pulse jet head 436 is provided by a head driver 432 under control of a computer 420. A computer 404 controls the timing of the firing of a pulse jet on head 436 through electronics 408, waveform generator 412, and amplifier 424, as well as the firing of strobe 416 through electronics 408. Digital images capture by CCD camera 428 are received and saved at computer 404. To acquire images of droplets this small moving with the speeds discussed here requires a high-speed strobe 416 such as a Nanolite strobe (available from High-Speed Photo-Systeme, Germany). The duration of the strobe is less than 100 ns and allows the drop to be effectively frozen in flight or during impact. Longer duration strobes are unsuitable and cause image blurring. A time history of the impact dynamics can be recorded by firing the strobe at predetermined times after a firing signal is sent to the pulse jet head 436. If the experiment is reproducible enough, a time history of the impact is recorded by synthesizing the individual images at computer 404 into a single time series.

Referring now to FIG. 6, the relationship between the splat diameter and feature spacing on an array 12 can be understood. In particular, if the features 16 are laid out in rows and columns with the same center to center spacing, d_{f}, of the features, then the maximum allowable splat radius, rₛ, is given by:

rₛ<d_{f}/2 (1)

On the other hand, where the alternate rows have their features 16 laid out in a staggered manner as illustrated in FIG. 7, with a center to center spacing feature spacing in the x direction of d_{fx} and in the y direction of d_{fx}, the maximum allowable splat radius rₛ is given by:

rₛ<(d_{fx}²+d_{fy}²)^{1/2}/2 (2)

Thus, in arrays formed from depositing drops containing the biopolymer or biopolymer precursor, if features are to be spaced as close together as theoretically possible to provide an array with the highest possible feature densities, then rₛ should take on the values of equation (1) or (2). For maximum feature density this would imply that drops deposited simultaneously at adjacent feature locations should produce resulting splat dimensions (illustrated as splat dimensions 4 in FIG. 8, which are splat diameters) which do not contact one another and are spaced apart by a distance Sₛₚ (see FIG. 8) which is greater than 0% of splat dimensions 4 but as small as possible. Note that in FIG. 8 resting dimensions 6 are the dimensions of the drops after they have retracted from their splat dimensions. In practice, good feature densities can still be obtained for an array 12 where Sₛₚ is less than 35% of the splat dimensions 4. Even better feature densities will be obtained where Sₛₚ is less than 25%, 20%, 15% 10%, or 5%,of the splat dimensions 4. The foregoing assume that the splat dimensions of drops deposited simultaneously or not at adjacent features are always equal. While this is typical in array fabrication by drop deposition, if for some reason they were to be different size then the average splat dimension or the largest splat dimension for drops deposited (simultaneously or not) at adjacent feature locations 16 could be used instead. When the drops deposited at adjacent features in a same cycle are not simultaneously deposited the same values of Sₛₚ could still be used as in the foregoing, although lower values could be used than in the situation of simultaneously deposited drops at adjacent features. However, simultaneously depositing drops at adjacent features allows for faster array fabrication by the drop deposition method since many features can be formed simultaneously. The foregoing non-simultaneously deposited drops at adjacent features situation during a cycle is the same as between cycles, since any liquid remaining after cycle is normally removed (for example, by washing) before the next cycle. In any method of the present invention, to allow some clearance distance between splat diameters for manufacturing variabilities and the like, Sₛₚ could be more than 1%, 2%, 5% or 8% of the splat dimensions 4. However, when splat dimension is reduced in relation to resting dimension then the array features may be spaced closer together. For example, drops deposited during a same cycle at adjacent feature locations may produce resulting splat dimensions which do not contact one another and each of which does not exceed its maximum resting dimension by more than 8% (or does not exceed its maximum resting dimension by more than.6%, 5%, 4% or 2%).

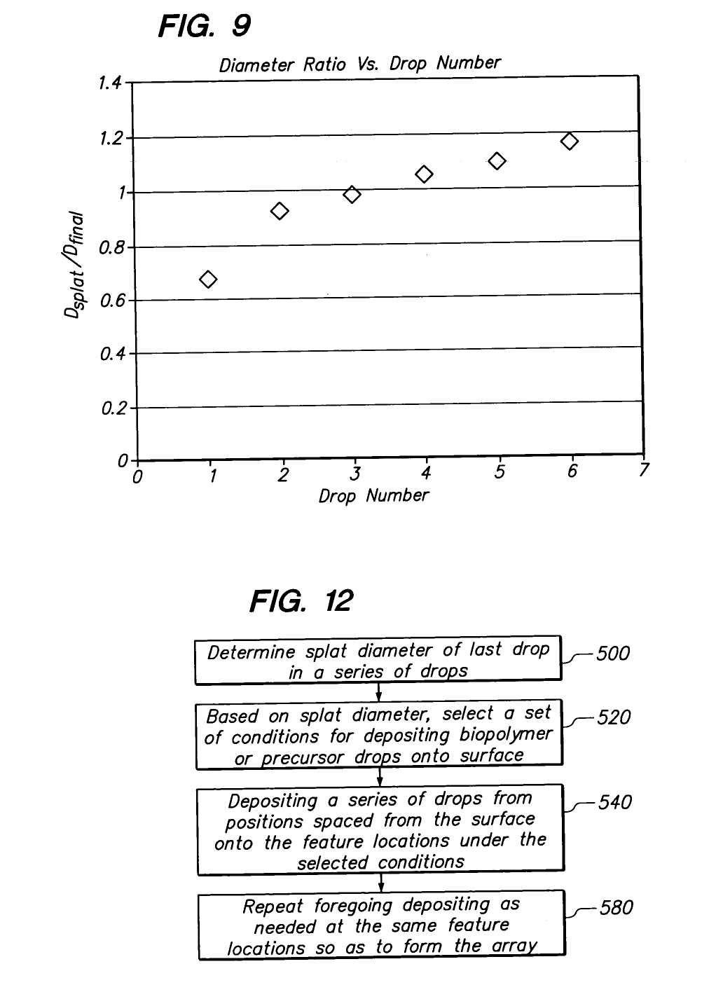

In some array fabrication techniques by drop deposition, such as by the in situ method, a series of multiple drops are deposited onto each feature location during each cycle of the fabrication. This technique can reduce the splat diameter versus depositing a single large drop with a volume equal to total volume of all the drops of the series. This can be understood with reference to FIG. 8. Without limiting the present invention, this is believed to result from splat diameter 4 being a function of kinetic energy of the impacting of the drop and the resistance to spreading due to elasticity of the surface (surface tension) and energy dissipation due to viscosity. For smaller drops, kinetic energy is more dominated by surface tension and viscous dissipation and therefore the splat diameter 4 is smaller than for larger drops. FIG. 9 illustrates this by showing the ratio of splat diameter to final diameter of an array feature location produced in a single cycle form a total of six drops, versus drop number. The first drop produces a splat diameter which is very near the final diameter. However, the sixth drop deposited on the existing resting droplet on the surface (the resting droplet having been formed by the merger of the previous five drops), produces a splat diameter only marginally larger than the final diameter. Without limiting the present invention, this is believed to likely result from the fact that at higher drop numbers a larger portion of the energy of impact is dissipated by viscous stresses and surface waves on the drop. As the number of drops in a series increases, the ratio of splat diameter to final diameter for a series should approach 1.

In the foregoing situation (multiple drops in a series for each adjacent feature) then, the last drops in the series for each of adjacent feature locations which are simultaneously deposited during the same cycle, can have characteristics such that they produce resulting splat dimensions which do not contact one another and are spaced apart by any of the dimensions described above. Further, in order to produce arrays with the highest feature density, it is best that drops deposited simultaneously for all sets of adjacent features of an array meet the limitations discussed above. However, if a lower feature density in some parts of the array was tolerable then this can be true for only less than all sets (for example, for only more than 20%, 40%, 50%, 80% or 90% of all drops deposited simultaneously at adjacent feature sets). Note that in the foregoing this means that if there were x sets of y adjacent features for which drops are deposited simultaneously, then the foregoing percentages are percentages of xy which can be taken over one cycle, multiple cycles, or all cycles).

It is also useful in the present invention to maintain splat dimensions as small as possible in relation to the resulting resting drop size in order to avoid undesirable regions where array features are only partially formed. Further, the surface energy properties of the drops and the surface should be matched to avoid drop splattering on impact. The effect of relatively large splat diameters and splattering from surface energy mismatch during array fabrication can be seen from FIG. 10 which are fluorescence images from a same array which was fabricated by an in situ process and exposed to a fluorescently labeled test sample (left image is linear signal scale image, while the right image is a log scale). In FIG. 10 drops of propylene carbonate/phosphoramidite solution were deposited onto a more hydrophilic surface. Note the features of the array have fuzzy edges with adjacent crescent features in many cases. The experiment was repeated using a more hydrophobic surface prepared in accordance with U.S. Pat. No. 6,444,268, and the images shown in FIG. 11. Note that in FIG. 11 the features formed have more clearly defined edges and crescents appear absent.

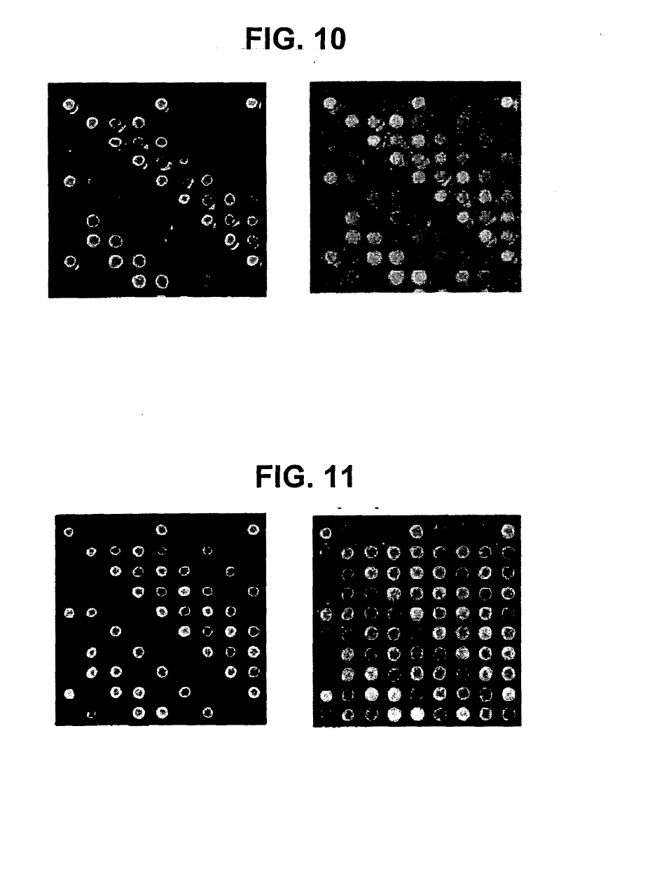

When it is desired to fabricate an array 12, a method as illustrated in FIG. 12 can be used. In the following description of FIG. 12, numbers in parentheses refer to the block number in FIG. 12. In particular, the splat dimension 4 of a last drop in a series of drops deposited onto a same location on a surface may be first determined (500). An apparatus as already described can be used to visualize the drops of interest and make this determination. Based on the determined splat dimension 4, a set of conditions is selected (520) for depositing a series of biopolymer or biopolymer precursor containing drops onto a surface 11a from positions spaced from surface 11a, so that drops simultaneously deposited at adjacent features will not contact one another. A series of drops is then deposited (540) from positions spaced from the surface onto the feature locations 16 using the selected conditions, so that each of the probes or probe precursors binds to the different feature locations. This depositing is repeated (580) as needed until the array 12 is formed.

In the foregoing method the set of conditions in (520) can be selected through experimental observation in the manner already described. If it is desired to alter the splat diameter, factors which will cause this include the material properties of the impacting drop and surface onto which the drop is deposited, including: surface tension, viscosity, density, velocity, resting drop diameter (or other dimension(s)), gravity, surface roughness, and mode of oscillation following drop impact. Other factors that may affect the splat diameter include angle of drop impact on the surface and temperature. These can be selected in (520) such that splat diameter (or splat dimension, more generally) has any of those values already discussed above. Such selected conditions may include a same value for any or all of the above conditions discussed above affecting splat diameter, as was used in the determining of splat dimension, such as a same: drop volume, velocity, viscosity, and distance from the substrate surface from which they are deposited. Alternatively, different values of these can be used. One set of parameters for typical array fabrication is provided in the following TABLE:

TABLE

| Symbol | Parameter | Value | |
|---|---|---|---|
| σ | Surface Tension | 40 | dync/cm |
| μ | Viscosity | 2-10 | cps |
| ρ | Density | 1.2 | g/m³ |
| V | Velocity | 10 | m/s |
| D | Diameter | 5 × 10⁻⁵ | m |
| G | Gravity | 9.8 | m/s² |
| ε | Surface Roughness | 2 | nm |

However, the Buckingham Pi theorem allows nondimensionalization of these variables to yield the four non-dimensional groups

$$Re = \frac{ρ VD}{μ} ; We = \frac{ρ {V}^{2} D}{σ} ; Fr = \frac{{V}^{2}}{Dg} ; r = \frac{ϵ}{D} ,$$

where Re is the Reynolds number, We the Weber number, Fr is the Froude number and r is a simple ratio of surface roughness to the characteristic drop length. Matching these parameters and the contact angle for each system should provide a geometrically similar resting drop diameter to splat diameter ratio. As usual, resting drop diameter is the total diameter of the resting fluid volume (including the deposited drop and any previously present liquid volume onto which the drop impacts, in the case of a series of drops) following impact.

Apparatus

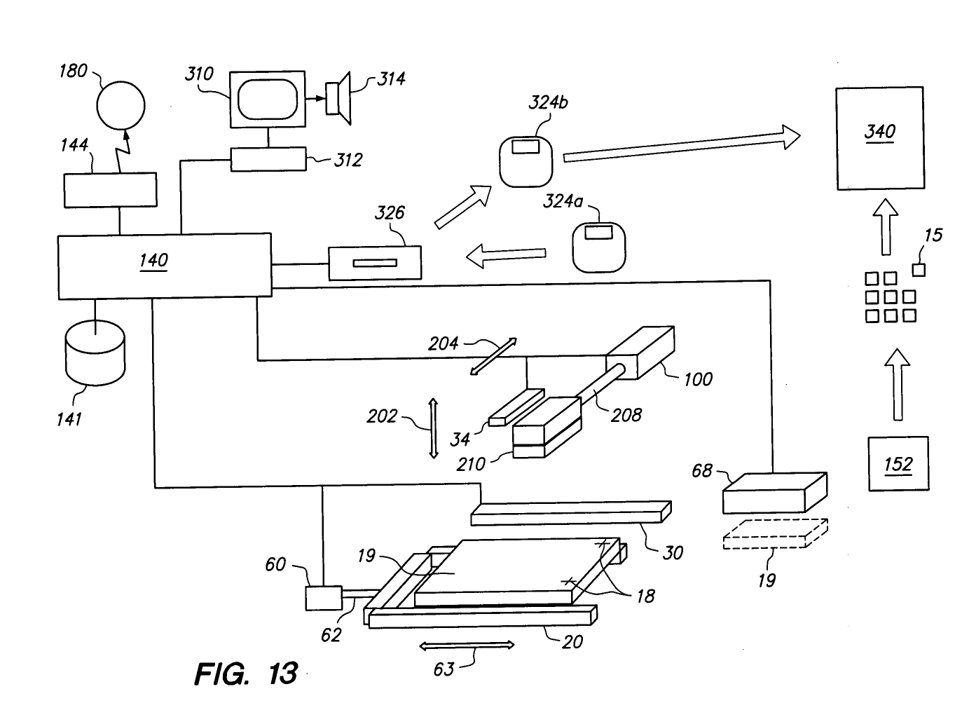

Referring now to FIG. 13, an apparatus of the present invention that can execute a method of the present invention, is illustrated. This apparatus is configured for use with a large substrate 19 which will later be cut into individual substrates 10 of any of the array assemblies 15. Substrate 19 will therefore also be referred to as having surfaces 11a and 11b. The apparatus of FIG. 13 includes substrate station 20 (sometimes referenced as a “substrate holder”) on which a substrate 19 can be mounted and retained. Pins or similar means (not shown) can be provided on substrate station 20 by which to approximately align substrate 19 to a nominal position thereon (with alignment marks 18 on substrate 19 being used for more refined alignment). Substrate station 20 can include a vacuum chuck connected to a suitable vacuum source (not shown) to retain a substrate 19 without exerting too much pressure thereon, since substrate 19 is often made of glass. A flood station 68 is provided which can expose the entire surface of substrate 19, when positioned at station 68 as illustrated in broken lines in FIG. 13, to a fluid typically used in the in situ process, and to which all features must be exposed during each cycle (for example, oxidizer, deprotection agent, and wash buffer). In the case of deposition of a previously obtained polynucleotide, flood station 68 need not be present.

A drop deposition system is present in the form of a dispensing head 210 which is retained by a head retainer 208. The head system can include more than one head 210 retained by the same head retainer 208 so that such retained heads move in unison together. The transporter system includes a carriage 62 connected to a first transporter 60 controlled by processor 140 through line 66, and a second transporter 100 controlled by processor 140 through line 106. Transporter 60 and carriage 62 are used execute one axis positioning of station 20 (and hence mounted substrate 19) facing the dispensing head 210, by moving it in the direction of axis 63, while transporter 100 is used to provide adjustment of the position of head retainer 208 (and hence head 210) in a direction of axis 204 (and therefore move head 210 in the direction of travel 204a which is one direction on axis 204). In this manner, head 210 can be scanned line by line along parallel lines in a raster fashion, by scanning along a line over substrate 19 in the direction of axis 204 using transporter 100, while line to line transitioning movement of substrate 19 in a direction of axis 63 is provided by transporter 60. Transporter 60 can also move substrate holder 20 to position substrate 19 in flood station 68 (as illustrated by the substrate 19 shown in broken lines in FIG. 13). Head 210 may also optionally be moved in a vertical direction 202, by another suitable transporter (not shown) and its angle of rotation with respect to head 210 also adjusted. It will be appreciated that other scanning configurations could be used during array fabrication. It will also be appreciated that both transporters 60 and 100, or either one of them, with suitable construction, could be used to perform the foregoing scanning of head 210 with respect to substrate 19. Thus, when the present application recites “positioning”, “moving”, or similar, one element (such as head 210) in relation to another element (such as one of the stations 20 or substrate 19) it will be understood that any required moving can be accomplished by moving either element or a combination of both of them. The head 210, the transporter system, and processor 140 together act as the deposition system of the apparatus. An encoder 30 communicates with processor 140 to provide data on the exact location of substrate station 20 (and hence substrate 19 if positioned correctly on substrate station 20), while encoder 34 provides data on the exact location of holder 208 (and hence head 210 if positioned correctly on holder 208). Any suitable encoder, such as an optical encoder, may be used which provides data on linear position.

Processor 140 also has access through a communication module 144 to a communication channel 180 to communicate with a remote station. Communication channel 180 may, for example, be a Wide Area Network (“WAN”), telephone network, satellite network, or any other suitable communication channel.

Each of one or more heads 210 may be of a type similar to that used in an ink jet type of printer and may, for example, include five or more chambers (at least one for each of four nucleoside phosphoramidite monomers plus at least one for an activator solution) each communicating with a corresponding set of multiple drop dispensing orifices and multiple ejectors which are positioned in the chambers opposite respective orifices. Each ejector is in the form of an electrical resistor operating as a heating element under control of processor 140 (although piezoelectric elements could be used instead). Each orifice with its associated ejector and portion of the chamber, defines a corresponding pulse jet. It will be appreciated that head 210 could, for example, have more or less pulse jets as desired (for example, at least ten or at least one hundred pulse jets, with their nozzles organized in rows and columns). Application of a single electric pulse to an ejector will cause a droplet to be dispensed from a corresponding orifice. Certain elements of the head 210 can be adapted from parts of a commercially available thermal inkjet print head device available from Hewlett-Packard Co. as part no. HP51645A. A suitable head construction is described in U.S. Pat. No. 6,461,812, incorporated herein by reference. Alternatively, multiple heads could be used instead of a single head 210, each being similar in construction to head 210 and being movable in unison by the same transporter or being provided with respective transporters under control of processor 140 for independent movement. In this alternate configuration, each head may dispense a corresponding biomonomer (for example, one of four nucleoside phosphoramidites) or an activator solution. Each head 210 of the head system in this case may also be of a type similar to that of each head 210, as already described. However, since each head will deliver only liquid drops of one type (solvent, or one of the two silanes) each head need only have one chamber to provide fluid to all the pulse jets of that head.

As is well known in the ink jet print art, the amount of fluid that is expelled in a single activation event of a pulse jet, can be controlled by changing one or more of a number of parameters, including the orifice diameter, the orifice length (thickness of the orifice member at the orifice), the size of the deposition chamber, and the size of the heating element, among others. The amount of fluid that is expelled during a single activation event is generally in the range about 0.1 to 1000 pL, usually about 0.5 to 500 pL and more usually about 1.0 to 250 pL. A typical velocity at which the fluid is expelled from the chamber is more than about 1 m/s, usually more than about 10 m/s, and may be as great as about 20 m/s or greater. As discussed above, when the orifice is in motion with respect to the substrate surface at the time an ejector is activated, the actual site of deposition of the material will not be the location that is at the moment of activation perpendicularly aligned with an orifice. However, the actual deposited location will be predictable for the given distances and velocities.

The apparatus further includes a display 310, speaker 314, and operator input device 312. Operator input device 312 may, for example, be a keyboard, mouse, or the like. Processor 140 has access to a memory 141, and controls print head system 78 and print head 210 (specifically, the activation of the ejectors therein), operation of the transporter system and the third transporter 72, and operation of display 310 and speaker 314. Memory 141 may be any suitable device in which processor 140 can store and retrieve data, such as magnetic, optical, or solid state storage devices (including magnetic or optical disks or tape or RAM, or any other suitable device, either fixed or portable). Processor 140 may include a general purpose digital microprocessor suitably programmed from a computer readable medium carrying necessary program code, to execute all of the steps required by the present invention, or any hardware or software combination which will perform those or equivalent steps. The programming can be provided remotely to processor 141 through communication channel 180, or previously saved in a computer program product such as memory 141 or some other portable or fixed computer readable storage medium using any of those devices mentioned below in connection with memory 141. For example, a magnetic or optical disk 324a may carry the programming, and can be read by disk writer/reader 326. A cutter 152 is provided to cut substrate 19 into individual array assemblies 15.

Operation of the Apparatus

The operation of the apparatus of FIG. 132 will now be described. It will be assumed that a substrate with a functionalized surface 11a is provided on substrate station 20 either manually or by a robot arm (not shown). It will be assumed that processor 140 is programmed with the necessary layout information to fabricate target arrays 12 using any of the methods (including drop splat diameters) discussed above. Such information on the layout would have already taken into account the splat dimensions of the drops to be deposited, in the manner described above. Using information such as the foregoing target layout and the number and location of drop dispensers in head 210, processor 140 can then determine a reagent drop deposition pattern. Alternatively, such a pattern could have been determined by another processor (such as a remote processor) and communicated to memory 141 through communication channel 180 or by forwarding a portable storage medium carrying such pattern data for reading by reader/writer 326. Processor 140 controls fabrication, in accordance with the deposition pattern, to generate the one or more arrays 12 on each section of substrate 19 which will later be cut into each substrate 10, by depositing for each target feature during each cycle, a reagent drop set as previously described. This is repeated at each of the different desired regions on the surface 11a for a substrate 10 (for example, the regions at each of the regions at which arrays 12a, 12b, 12c, 12d will be formed) so that the probe or probe precursors bind to the different regions through the linker agent. The foregoing sequence is repeated for each cycle of the in situ fabrication process. Drops are deposited from the head while moving along each line of the raster during scanning. No drops are dispensed for features or otherwise during line transitioning. Processor 140 also sends substrate 19 to flood station 68 for cycle intervening or final steps as required, all in accordance with the conventional in situ polynucleotide array fabrication process described above.

As a result of the above, multiple array assemblies are formed on each section which will be cut to form a substrate 10, so as to form the array thereon with features of different probe composition in a region which features are repeated in another region but with a different probe density.

The substrate 19 may then be sent to a cutter 152 wherein sections of substrate 19 are separated into substrates 10 carrying one ore more arrays 12, to provide multiple array assemblies 15. One or more array assemblies 15 may then be forwarded to one or more remote users. Processor 140 also causes deposition of drops from all multi-dispenser drop groups to be deposited at separate test locations, such as at a test pattern 250 which may be separate from arrays 12 as already described above. The foregoing array fabrication sequence can be repeated at the fabrication station as desired for multiple substrates 19 in turn.

During array fabrication errors can be monitored and used in any of the manners described in U.S. Patent Application “Polynucleotide Array Fabrication” by Caren et al., Ser. No. 09/302898 filed Apr. 30, 1999, and U.S. Pat. No. 6,232,072. Also, the one or more identifiers in the form of bar codes 356 can be attached or printed onto sections of substrate 19 defining the substrates 10 before entering, or after leaving, first fabrication station 70, or after leaving the second fabrication station 20. Regardless of the foregoing, at any point in the operation of the apparatus of FIG. 13, processor 140 will associate (540) each array with an identifier such as a bar code 356, which identifier carries an indication of the array layout and any other desired information regarding the array or its fabrication parameters, or is linked to a file carrying such information. The file and linkage can be stored by processor 140 and saved into memory 141 or can be written onto a portable storage medium 324b which is then placed in the same package 340 as the corresponding array assembly 15 for shipping to a remote customer. Optionally other characteristics of the fabricated arrays can be included in the code 356 applied to the array substrate or a housing, or a file linkable to such code, in a manner as described in the foregoing patent application and U.S. Pat. No. 6,180,351. As mentioned above, these references are incorporated herein by reference.

Array Use

All arrays 12 on unit 15 can be read at the same time by using any suitable reading apparatus. Where fluorescent light is to be detected due to incorporation of fluorescent labels into the target in a known manner, well known array readers can be used. For example, such a reader may scan one or more illuminating laser beams across each array in raster fashion and any resulting fluorescent signals detected, such as described in U.S. Pat. No. 6,406,849.

Results from the array reading can be further processed results, such as obtained by rejecting a reading for a feature which is below a predetermined threshold and/or forming conclusions based on the pattern read from the array (such as whether or not a particular target sequence may have been present in the sample or an organism from which the sample was obtained exhibits a particular condition or disease). The results of the reading (processed or not) can be forwarded (such as by communication) to be received at a remote location for further evaluation and/or processing, or use, using communication channel 180 or reader/writer 186 and medium 190. This data may be transmitted by others as required to reach the remote location, or retransmitted to elsewhere as desired.

In a variation of the embodiments above, it is possible that each array assembly 15 may be contained with a suitable housing. Such a housing may include a closed chamber accessible through one or more ports normally closed by septa, which carries the substrate 10. In this case, the identifier for all arrays on a substrate 10 can be associated with them by being applied to the housing. It will also be appreciated that arrays may be read by any other method or apparatus than that described above, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,251,685, U.S. Pat. No. 6,221,583 and elsewhere). As to retrieving signal data from features (“feature extraction”) in which features and their corresponding signals are identified in an image of a read array, this can be performed using procedures such as described in U.S. patent application Ser. Nos. 09/589046, 09/659415 and 10/086839, all under the title “Method And System For Extracting Data From Surface Array Deposited Features”.

The substrate surface onto which the polynucleotide compositions or other moieties is deposited may be porous or non-porous, smooth or substantially planar, or have irregularities, such as depressions or elevations. The substrate may be of one material or of multi-layer construction. Also, instead of drop deposition methods for fabricating an array on the functionalized substrate, photolithographic array fabrication methods may be used. Where a pattern of arrays is desired, any of a variety of geometries may be constructed other than the organized rows and columns of arrays 12 of FIG. 1. For example, arrays 12 can be arranged in a series of curvilinear rows across the substrate surface (for example, a series of concentric circles or semi-circles of spots), and the like. Similarly, the pattern of features 16 may be varied from the organized rows and columns of features in FIG. 2 to include, for example, a series of curvilinear rows across the substrate surface(for example, a series of concentric circles or semi-circles of spots), and the like. While various configurations of the features can be used, the user should be provided with some means (for example, through the array identifier) of being able to ascertain at least some characteristics of the features (for example, any one or more of feature composition, location, size, performance characteristics in terms of significance in variations of binding patterns with different samples, or the like). The configuration of the array may be selected according to manufacturing, handling, and use considerations. The present methods and apparatus may be used to fabricate and use arrays of other biopolymers, polymers, or other moieties on surfaces in a manner analogous to those described above. Accordingly, reference to polymers, biopolymers, or polynucleotides or the like, can often be replaced with reference to “chemical moieties”.

Various further modifications to the particular embodiments described above are, of course, possible. Accordingly, the present invention is not limited to the particular embodiments described in detail above.

What is claimed is:

1. A method of fabricating an array of biopolymer probes bound to a surface of a substrate at different feature locations of the array, comprising:
(a) depositing drops which contain probes or probe precursors from positions spaced from the surface onto the feature locations, so that each of the probes or probe precursors binds to the different feature locations; and
(b) repeating (a) as needed at the same feature locations so as to form the array;
wherein drops deposited during a same cycle at adjacent feature locations produce resulting splat dimensions which do not contact one another and are spaced apart by less than 35% of a largest one of their splat dimensions.

2. A method according to claim 1 wherein:
in (a) a series of multiple drops are deposited onto each feature location during a cycle;
the last drops in the series for each of adjacent feature locations during a same cycle are simultaneously deposited, and produce resulting splat dimensions which do not contact one another and are spaced apart by less than 25% of a largest one of their splat dimensions.

3. A method according to claim 2 wherein the biopolymer probes are selected from polynucleotide probes and peptide probes.

4. A method according to claim 3 wherein drops deposited during a same cycle at adjacent feature locations produce resulting splat dimensions which are spaced apart by less than 25% of a largest one of their splat dimensions.

5. A method according to claim 3 wherein adjacent features are spaced apart by a distance greater than 0 and less than 35% of a maximum dimension of the feature.

6. A method according to claim 3 wherein adjacent features are spaced apart by a distance greater than 0 and less than 20% of a maximum dimension of the feature.

7. A method according to claim 5 wherein the features are round.

8. A method according to claim 3 wherein (a) is repeated multiple times at each feature.

9. A method according to claim 3 wherein the features have a maximum dimension of between 20 to 125 microns and are spaced apart by less than 40 microns.

10. A method according to claim 3 wherein the features have a maximum dimension of greater than 50 microns and are spaced apart by less than 40 microns.

11. A method according to claim 3 wherein the features have a maximum dimension of greater than 50 microns and a density on the surface of at least 30 features/mm².

12. A method according to claim 12 wherein the features are at a density on the surface of at least 40 features/mm².

13. A method according to claim 3 wherein the array has at least one thousand feature locations and the drops deposited during a same cycle at adjacent feature locations of at least one thousand feature locations produce resulting splat dimensions which do not contact one another and are spaced apart by less than 30% of a largest one of their splat dimensions.

14. A method according to claim 1 additionally comprising, prior to (a), determining the splat dimension for drops deposited during a same cycle at adjacent feature locations, and selecting a feature location spacing based on the determined splat dimension.

15. A method according to claim 2 additionally comprising, prior to (a), determining the splat dimension for the last drops in the series for each of adjacent feature locations, and selecting a feature location spacing based on the determined splat dimension.

16. A method comprising determining the splat dimension of a last drop in a series of drops deposited onto a same location on a surface.

17. A method according to claim 16 additionally comprising fabricating an array of chemical probes bound to a surface of a substrate at different feature locations of the array, including:
(a) based on the determined splat dimension selecting a set of conditions for depositing a series of drops containing polynucleotide, peptide, or monomer units of either onto the substrate surface from positions spaced therefrom, so that drops simultaneously deposited at adjacent features will not contact one another;
(b) depositing a series of drops from positions spaced from the surface onto the feature locations under the selected conditions, so that each of the probes or probe precursors binds to the different feature locations, and
(c) repeating (b) as needed at the same feature locations so as to form the array.

18. A method according to claim 17 wherein the selected set of conditions includes a same drop volume, velocity, viscosity, and distance from the substrate surface from which they are deposited, as used in the determining of splat dimension.

19. A method according to claim 17 the selected set of conditions is such that the splat dimension does not exceed resting drop size by more than 10%.

20. A method comprising determining the splat dimension of drops containing a polynucleotide, peptide, or monomer units of either, which are deposited onto a surface from positions spaced therefrom.

21. An array of chemical probes bound to a surface of a substrate at different features of the array, wherein the array has at least one thousand features each with a maximum dimension of between 20 to 150 microns and which are spaced apart from adjacent features by less than 35% of their maximum dimension.

22. An array according to claim 21 wherein the features have a maximum dimension of greater than 50 microns and less than 120 microns.

23. An array according to claim 21 wherein the features have a maximum dimension of greater than 50 microns and a density on the surface of at least 30 features/mm².

24. An array according to claim 23 wherein the features are at a density on the surface of at least 40 features/mm².

25. An array according to claim 23 wherein the features are round.

26. A method according to claim 1 wherein the drops deposited during a same cycle at adjacent feature locations and which produce resulting splat dimensions which-do not contact one another and are spaced apart by less than 35% of a largest one of their splat dimensions, each have a splat dimension which does not exceed a maximum resting dimension of the drop by more than 8%.

27. A method according to claim 1 wherein the drops deposited during a same cycle at adjacent feature locations and which produce resulting splat dimensions which do not contact one another and are spaced apart by less than 35% of a largest one of their splat dimension, each have splat dimensions which does not exceed a maximum resting dimension of the drop by more than 5%.

28. A method comprising exposing an array of claim 21 to a sample and reading the array.

29. A method comprising forwarding results from the reading of an array according to the method of claim 28 to a remote location.

30. A method comprising receiving results from the reading of an array according to the method of claim 28 from a remote location.

31. A method of fabricating an array of biopolymer probes bound to a surface of a substrate at different feature locations of the array, comprising:
(a) depositing drops which contain probes or probe precursors from positions spaced from the surface onto the feature locations, so that each of the probes or probe precursors binds to the different feature locations; and
(b) repeating (a) as needed at the same feature locations so as to form the array;
wherein drops deposited during a same cycle at adjacent feature locations produce resulting splat dimensions which do not contact one another and each of which does not exceed a maximum resting dimension of the drop by more than 8%.

32. A method according to claim 31 wherein drops deposited during a same cycle at adjacent feature locations produce resulting splat dimensions which do not contact one another and each of which does not exceed a maximum resting dimension of the drop by more than 5%.
